(19) United States
(12) Patent Application Publication
(10) Pub. No.: US 2026/0341793 A1
(43) Pub. Date: Oct. 29, 2026

(54) CYLINDRICAL LITHIUM-ION BATTERY

(71) Applicant: SHENZHEN CAPCHEM TECHNOLOGY CO., LTD., SHENZHEN (CN)

(72) Inventors: XIONGGUI LIN, SHENZHEN (CN); CHENQI PI, SHENZHEN (CN); XIAOXIA XIANG, SHENZHEN (CN)

(21) Appl. No.: 19/467,821

(22) Filed: Feb. 3, 2026

Related U.S. Application Data
(63) Continuation of application No. PCT/CN2024/097974, filed on Jun. 7, 2024.

(30) Foreign Application Priority Data
Aug. 16, 2023 (CN) 202311032321.5

(51) Int. Cl. H01M 10/0569; H01M 4/587; H01M 10/0525; H01M 10/0568; H01M 50/107

(52) U.S. Cl. CPC H01M 10/0569; H01M 4/587; H01M 10/0525; H01M 10/0568; H01M 50/107; H01M 2300/0037

(57) ABSTRACT

Provided is a cylindrical lithium-ion battery, which comprises a cathode, an anode, and a non-aqueous electrolyte. The anode comprises an anode material layer containing an anode active material, and the anode active material includes a silicon-based material. The non-aqueous electrolyte comprises a non-aqueous organic solvent and lithium salts. The non-aqueous organic solvent comprises a chain carbonate containing dimethyl carbonate, and the lithium salts comprise LiPF₆ and a lithium fluorosulfonylimide. The cylindrical lithium-ion battery meets the following condition: 0.05≤(100−D)×F/S≤8.75, with 50≤D≤75, 0.012≤F≤1, and 5≤S≤20. The cylindrical lithium-ion battery provided by the present application can effectively improve the rate capability, room-temperature cycle performance, and high-temperature storage performance of cylindrical lithium-ion batteries, thereby improving their service lives.

### TECHNICAL FIELD

The present application relates to the technical field of secondary battery, and particularly to a cylindrical lithium-ion battery.

### BACKGROUND

Due to the advantages such as simple design, standardized manufacturing technology, straightforward process, low cost, and high application flexibility, cylindrical batteries are favored by major manufacturers. When traditional cylindrical batteries are used as power batteries, they have no advantage due to their small sizes. To solve this problem, the existing cylindrical batteries are being designed with increasingly larger dimensions. So far, the diameters of cylindrical batteries have increased to 46 mm, which makes the energy density of cylindrical battery cells further rise. Because the pole pieces of cylindrical batteries are designed to be wound, the pole pieces are bound by winding tension after being wound layer by layer, which can effectively suppress the expansion of the pole pieces. This design is more suitable for silicon anodes with large volume expansion after charging and discharging. The cells design of cylindrical batteries is compatible with high energy density material systems.

Silicon-containing anodes exhibit a significant volume expansion effect. The lithium-silicon alloying and dealloying processes are accompanied by severe expansion and contraction of the anode, which causes the solid electrolyte interface (SEI) film on the surface of the anode to continuously rupture and regenerate, resulting in the consumption and active lithium loss of the electrolyte, increased interface impedance, and thus deteriorating cycle performance. Moreover, as charging and discharging proceed, the thickness of the anode pole piece increases, squeezing the protection enclosure for the battery, which may cause the enclosure to break and bring safety hazards. The increase in thickness makes the contact between the active material and the copper foil current collector worse, affecting the electronic conductivity, and the battery capacity decays sharply in the later stage of cycle, resulting in a “diving” phenomenon.

At present, in the industry, the predominantly used approach for improving the energy density of cylindrical batteries is the use of cathode and anode active materials with high specific capacities. The theoretical specific capacities of silicon-based anodes are about 10 times those of existing graphite anodes. Therefore, increasing the silicon content in the anode material of the battery cell is one of the important development directions for achieving high specific energy of batteries. For every 10% increase in energy density, the cycle life is reduced by 25%. The cycle life of the battery cell prepared using high energy density materials is a shortcoming. It is challenging for existing cylindrical batteries to improve their cycle live while taking into account high energy density.

Therefore, it is imperative to develop a cylindrical lithium-ion battery to addressing the aforementioned technical drawbacks of the prior art.

### SUMMARY

Based on the aforementioned problems, the present application is directed to providing a cylindrical lithium-ion battery exhibiting the advantages of high energy density, excellent room-temperature cycle performance, and superior high-temperature storage performance, and the like.

In order to achieve the aforementioned objective, present application adopts the following technical solutions:
a cylindrical lithium-ion battery, comprising a cathode, an anode, and a non-aqueous electrolyte; the anode comprises an anode material layer containing an anode active material, wherein comprises a silicon-based material; the non-aqueous electrolyte comprises a non-aqueous organic solvent and lithium salts; the non-aqueous organic solvent comprises a chain carbonate containing dimethyl carbonate (DMC), and the lithium salts comprise a LiPF₆ and a lithium fluorosulfonylimide;
the cylindrical lithium-ion battery satisfies the following conditions:

0.05≤(100−D)×F/S≤8.75, with 50≤D≤75, 0.012≤F≤1, and 5≤S≤20;
wherein D is the mass percentage of DMC in the non-aqueous electrolyte, in wt %;
F is the ratio of the molar content of the lithium fluorosulfonylimide to the molar content of LiPF₆ in the non-aqueous electrolyte; and
S is the mass percentage of silicon in the anode material layer, in wt %.

In some embodiments, the cylindrical lithium-ion battery satisfies the following condition: 0.1≤(100−D)×F/S≤7.5.

In some embodiments, the mass percentage D of DMC in the non-aqueous electrolyte is 55 wt % to 67 wt %.

In some embodiments, the ratio F of the molar content of the lithium fluorosulfonylimide to the molar content of LiPF₆ in the non-aqueous electrolyte is 0.06 to 0.85.

In some embodiments, the mass percentage S of silicon in the anode material layer is 7 wt % to 15 wt %.

In some embodiments, the silicon-based material comprises one or more materials selected from the group consisting of silicon materials, silicon oxide materials, silicon-carbon composite materials, and silicon alloy materials; and in some preferred embodiments, the anode active material is selected from silicon-carbon composite materials.

In some preferred embodiments, the silicon materials are nano-silicon materials; the silicon oxide materials are SiOₓ materials, with 0<x<2; the silicon-carbon composite materials are silicon-based materials comprising silicon and carbon materials and/or silicon-based materials containing SiO_{y} and carbon materials, with 0<y<2; and the silicon alloy materials are Mg₂Si alloy materials and/or Fe₂Si alloy materials.

In some embodiments, the lithium fluorosulfonylimide comprises one or more compounds selected from the group consisting of lithium bis(fluorosulfonyl)imide (LiFSI) and lithium bis(trifluoromethanesulfonyl)imide (LiTFSI).

In some embodiments, the lithium salts further comprises one or more compounds selected from the group consisting of LiBOB, LiDFOB, LiDFOP, LiPO₂F₂, LiBF₄, LiSbF₆, LiAsF₆, LiN(SO₂CF₃)₂, LiN(SO₂C₂F₅)₂, LiC(SO₂CF₃)₃, LiClO₄, LiAlCl₄, LiCF₃SO₃, LiSO₃F, Li₂B₁₀Cl₁₀, lithium chloroborane, lithium tetrafluorooxalatophosphatel, lithium trioxalatophosphate, lower aliphatic carboxylic acid lithium salts with fewer than 4 carbon atoms, and/or lithium tetraphenylborate.

In some embodiments, the total molar content of the lithium salts is 0.9 mol/L to 3.5 mol/L, with 0.012≤F≤1; and in some preferred embodiments, the total molar content of the lithium salts is 1.1 mol/L to 1.5 mol/L, with 0.06≤F≤0.85.

In some embodiments, the non-aqueous organic solvent further comprises one or more compounds selected from the group consisting of a cyclic carbonate, a carboxylate ester, and an ether.

In some preferred embodiments, the cyclic carbonate comprises one or more compounds selected from the group consisting of ethylene carbonate, fluoroethylene carbonate, vinylene carbonate, propylene carbonate, and butylene carbonate.

The chain carbonate further comprises one or more compounds selected from the group consisting of diethyl carbonate, ethyl methyl carbonate, and propyl methyl carbonate.

The carboxylate ester comprises one or more compounds selected from the group consisting of methyl acetate, ethyl acetate, propyl acetate, methyl propionate, ethyl propionate, propyl propionate, methyl butyrate, methyl isobutyrate, ethyl butyrate, methyl trimethylacetate, and ethyl trimethylacetate.

The ether comprises one or more compounds selected from the group consisting of dimethoxyethane, 1,3-dioxolane, and 1,1,2,2-tetrafluoroethyl-2,2,3,3-tetrafluoropropyl ether.

In some embodiments, the non-aqueous electrolyte further comprises an additive, which comprises one or more compounds selected from the group consisting of a cyclic carbonate compound, a cyclic sulfate compound, a sultone compound, a phosphate ester compound, a borate ester compound, and a nitrile compound; and the content of the additive is 0.01% to 10% when the total mass of the non-aqueous electrolyte is taken as 100%.

In some preferred embodiments, the cyclic carbonate compound comprises one or more compounds selected from the group consisting of vinylene carbonate, ethylene carbonate, methylene ethylene carbonate, fluoroethylene carbonate, trifluoromethyl ethylene carbonate, difluoroethylene carbonate, and compounds represented by the following structural formula 1:

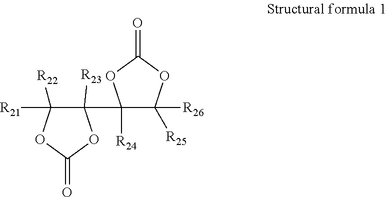

wherein R₂₁, R₂₂, R₂₃, R₂₄, R₂₅, and R₂₆ are independently selected from hydrogen atom, halogen atom, and C1 to C5 groups.

The cyclic sulfate compound comprises one or more compounds selected from the group consisting of vinyl sulfate, 4-methylvinyl sulfate, and propylene sulfate.

The sultone compound comprises one or more compounds selected from the group consisting of 1,3-propanesultone, 1,4-butanesultone, and prop-1-ene-1,3-sultone.

The phosphate ester compound comprises one or more compounds selected from the and compounds represented by the following structural formula 2:

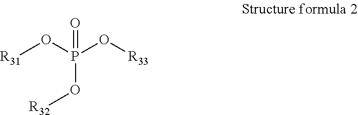

wherein R₃₁, R₃₂, and R₃₃ are independently selected from C1 to C5 saturated hydrocarbon groups, unsaturated hydrocarbon groups, halogenated hydrocarbon groups, and —Si(CₘH₂ₘ₊₁)₃, wherein m is a natural number in the range from 1 to 3, and at least one of R₃₁, R₃₂, and R₃₃ is an unsaturated hydrocarbon group.

The borate ester compound comprises one or more compounds selected from the group consisting of tris(trimethylsilane) borate ester and tris(triethylsilane) borate ester.

The nitrile compound comprises one or more compounds selected from the group consisting of succinitrile, glutaronitrile, ethylene glycol bis(propionitrile) ether, hexanetrinitrile, adiponitrile, dicyanopentane, octanedinitrile, azelanitrile, and sebacoitrile.

The present application provides a cylindrical lithium-ion battery, wherein the anode active material comprises a silicon-based material, and the non-aqueous electrolyte comprises a non-aqueous organic solvent containing DMC and lithium salts containing LiPF₆ and lithium fluorosulfonylimide. For lithium-ion batteries with high energy density systems containing silicon anodes, when DMC is selected as the non-aqueous organic solvent of the electrolyte, it can significantly improve the wettability and fluidity of the non-aqueous electrolyte; and when the lithium fluorosulfonylimide and LiPF₆ are selected as the lithium salts, they can improve the conductivity, electrochemical performance, thermal stability, and hydrolysis resistance. Based on own experience and a large number of studies, the inventors find that when the mass percentage D of DMC in the non-aqueous electrolyte, the ratio F of the molar content of the lithium fluorosulfonylimide to the molar content of LiPF₆ in the non-aqueous electrolyte, and the mass percentage S of silicon in the anode material layer satisfy the condition of 0.05≤(100−D)×F/S≤8.75, within 50≤D≤75, 0.012≤F≤1, and 5≤S≤20, these values can effectively suppress the volume change of silicon anodes, and improve the problems such as consumption and active lithium loss of the electrolyte, interface impedance increase, cycle performance degradation, and rapid battery capacity attenuation in the later stage of cycle, thereby improving the rate capability, room temperature cycle performance, and ultra-high temperature storage performance of cylindrical lithium-ion batteries, and increasing their service lives.

### DETAILED DESCRIPTION OF THE EMBODIMENTS

Unless otherwise specified, conditions not explicitly stated for the experimental methods in the following embodiments of the present application shall be understood as conventional conditions or conditions recommended by manufacturers. The common chemical reagents used in the embodiments are all commercially available products.

Unless otherwise defined, all technical and scientific terms used in the present application have the same meanings as those commonly understood by those skilled in the technical field of the present application. The terms used in the specification of the present application are only for the purpose of describing specific embodiments and are not intended to limit the present application.

In addition, the terms “comprising”, “having”, and any variations thereof used in the present application are intended to cover a non-exclusive inclusion. For example, a process, method, apparatus, product, or device comprising a series of steps or units is not limited to only those expressly listed steps or units but optionally further includes steps or modules that are not listed, or optionally further includes other steps or units inherent to the process, method, apparatus, or product.

As used herein, the term “multiple” means two or more.

This embodiment provides a cylindrical lithium-ion battery, comprising a cathode, an anode, and a non-aqueous electrolyte; the anode comprises an anode material layer containing an anode active material, which comprises a silicon-based material; the non-aqueous electrolyte comprises a non-aqueous organic solvent and lithium salts; the non-aqueous organic solvent comprises a chain carbonate containing DMC, and the lithium salts comprises LiPF₆ and a lithium fluorosulfonylimide.

The cylindrical lithium-ion battery satisfies the following condition:

0.05≤(100−D)×F/S≤8.75, with 50≤D≤75, 0.012≤F≤1, and 5≤S≤20;
wherein D is the mass percent of DMC in the non-aqueous electrolyte, in wt %;
F is the molar ratio of lithium fluorosulfonylimide to LiPF₆ in the non-aqueous electrolyte;
S is the mass percent of silicon in the anode material layer, in wt %.

For the cylindrical lithium-ion battery provided by the embodiment, the anode active material comprises a silicon-based material, and the non-aqueous electrolyte comprises a non-aqueous organic solvent containing DMC and lithium salts containing LiPF₆ and lithium fluorosulfonylimide. For lithium-ion batteries with high energy density systems containing silicon anodes, when DMC is selected as the non-aqueous organic solvent of the electrolyte, it can significantly improve the wettability and fluidity of the non-aqueous electrolyte; and when the lithium fluorosulfonylimide and LiPF₆ are selected as the lithium salts, they can improve the conductivity, electrochemical performance, thermal stability, and hydrolysis resistance. Based on own experience and a large number of studies, the inventors find that when the mass percentage D of DMC in the non-aqueous electrolyte, the ratio F of the molar content of the lithium fluorosulfonylimide to the molar content of LiPF₆ in the non-aqueous electrolyte, and the mass percentage S of silicon in the anode material layer satisfy the condition of 0.05≤(100−D)×F/S≤8.75, with 50≤D≤75, 0.012≤F≤1, and 5≤S≤20, these values can effectively suppress the volume change of silicon anodes, and improve the problems such as consumption and active lithium loss of the electrolyte, interface impedance increase, cycle performance degradation, and rapid battery capacity attenuation in the later stage of cycle, thereby improving the rate capability, room temperature cycle performance, and ultra-high temperature storage performance of cylindrical lithium-ion batteries, and increasing their service lives.

In specific embodiments, the value of (100−D)×F/S may be but is not limited to 0.05, 0.07, 0.09, 0.1, 1.2, 1.5, 1.6, 1.8, 2, 2.1, 2.3, 2.5, 2.7, 3, 3.2, 3.6, 3.8, 4, 4.2, 4.5, 4.7, 5, 5.4, 5.6, 5.8, 6, 6.2, 6.4, 6.6, 6.8, 7, 7.2, 7.4, 7.5, 7.8, 8.0, 8.2, 8.5, or 8.75.

In some preferred embodiments, the cylindrical lithium-ion battery satisfies the following condition: 0.1≤(100−D)×F/S≤7.5. This range, which is encompassed by the broader relationship 0.05≤(100−D)×F/S≤8.75, can provide enhanced suppression of volume expansion in the silicon-based anode, thereby improving cycle performance and service life of the lithium-ion battery having a high-energy-density system comprising a silicon-based anode.

In specific embodiments, the mass percentage D of DMC in the non-aqueous electrolyte may be but is not limited to 50 wt %, 52 wt %, 55 wt %, 58 wt %, 60 wt %, 62 wt %, 65 wt %, 67 wt %, 69 wt %, 70 wt %, 72 wt %, 74 wt %, or 75 wt %.

In some preferred embodiments, the mass percentage D of DMC in the non-aqueous electrolyte is 55 wt % to 67 wt %.

Cylindrical batteries are tightly wound structure with compact materials and relatively small internal volume, thus, a prerequisite for the non-aqueous electrolyte to function effectively good wettability and fluidity. The viscosity of the chain carbonate is lower than that of the cyclic carbonate, and DMC has the lowest viscosity among commonly used non-aqueous organic solvents. Accordingly, it exhibits the best conductivity enhancement effect. However, DMC is prone to generate gas in high-temperature environments, and the dosage also needs to be controlled. When 50 wt % to 75 wt % DMC is used as a component of the non-aqueous organic solvent in the non-aqueous electrolyte, it can greatly improve the wettability and fluidity of the non-aqueous electrolyte. Especially when the mass percent D of DMC is 55 wt % to 67 wt %, it can better improve the wettability and fluidity of the non-aqueous electrolyte of the present application.

The conductivity of anodes containing silicon-based materials are not as good as those of graphite anodes. Compared with LiPF₆, the lithium fluorosulfonylimide in the non-aqueous electrolyte has better conductivity, higher electrochemical and thermal stability, and hydrolysis resistance, which help to reduce the internal resistance of the battery, reduce heat generation, improve discharge efficiency, and enhance battery safety. However, the high content of the lithium fluorosulfonylimide tends to cause aluminum foil corrosion. Therefore, when the ratio F of the molar content of the lithium fluorosulfonylimide to the molar content of LiPF₆ in the non-aqueous electrolyte is adjusted to the range from 0.012 to 1, aluminum foil corrosion can be avoided to a great extent. Especially, when the F value is in the range from 0.06 to 0.85, the battery performance can be better balanced. When the mass percentage D of DMC in the non-aqueous electrolyte is reduced to increase the proportion of (100−D), it is necessary to adjust the ratio F of the molar content of the lithium fluorosulfonylimide to the molar content of LiPF₆, to ensure that the system has sufficient conductivity. In addition, the introduction of an appropriate amount of lithium fluorosulfonylimide into a cylindrical battery system containing silicon-based anodes can further optimize the rate capability of the battery, prolong its cycle life, and improve its high-temperature stability.

In specific embodiments, the mass percentage S of silicon in the anode material layer may be but is not limited to 5 wt %, 7 wt %, 9 wt %, 10 wt %, 12 wt %, 14 wt %, 15 wt %, 17 wt %, 19 wt %, or 20 wt %.

The silicon-based material can effectively enhance the energy density of the battery, but its huge volume effect cannot be ignored. Especially, as the silicon content increases, this negative impact will increase exponentially. The high-strength enclosure for the cylindrical battery can mitigate the damage to the battery body caused by gas generation from electrolyte decomposition and material volume expansion to a certain extent. Moreover, the electrolyte is designed by a coordinated regulation of the silicon content and key components, to further optimize the volume effect, in which (100−D) is taken as the control parameter to adjust the DMC content (reducing this content to reduce the pressure of the gases generated) and the F value according to the change of the silicon content S, taking into account the electrolyte adaptability to cylindrical batteries with different silicon contents.

In some embodiments, the silicon-based material comprises one or more materials selected from the group consisting of silicon materials, silicon oxide materials, silicon-carbon composite materials, and silicon alloy materials.

In some embodiments, the silicon materials are nano-silicon materials; the silicon oxide materials are SiOₓ materials, with 0<x<2; the silicon-carbon composite materials are silicon-based materials comprising silicon and carbon materials and/or silicon-based materials containing SiO_{y} and carbon materials, with 0<y<2; and the silicon alloy materials are Mg₂Si alloy materials and/or Fe₂Si alloy materials.

Silicon materials have high specific capacities. However, due to their lithium insertion mechanism, they are highly susceptible to volume expansion, resulting in cracking and failure of electrode materials. As a comparison, carbon materials are more stable than silicon materials.

In some preferred embodiments, the anode active material is selected from silicon-carbon composite materials. In the silicon-carbon composite materials, silicon and carbon form a complementary relationship, so that the high specific capacity of the silicon matrix is combined with the cycle stability of the carbon phase, which can effectively solve the problem of failure due to material expansion and ensure good cycle performance at the same time.

In specific embodiments, the ratio F of the molar content of the lithium fluorosulfonylimide to the molar content of LiPF₆ in the non-aqueous electrolyte may be but is not limited to 0.012, 0.05, 0.06, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1.

In some preferred embodiments, the molar content of the lithium fluorosulfonylimide in the non-aqueous electrolyte is 0.01 mol/L to 0.9 mol/L; and more preferably, the molar content of the lithium fluorosulfonylimide in the non-aqueous electrolyte is 0.1 mol/L to 0.6 mol/L.

In preferred embodiments, the molar content of LiPF₆ in the non-aqueous electrolyte is 0.5 mol/L to 2.0 mol/L; and more preferably, the molar content of LiPF₆ in the non-aqueous electrolyte is 0.6 mol/L to 1.3 mol/L.

In some preferred embodiments, the lithium fluorosulfonylimide comprises one or more compounds selected from the group consisting of lithium bis(fluorosulfonyl)imide (LiFSI) and lithium bis(trifluoromethylsulfonyl)imide (LiTFSI).

In some embodiments, the lithium salts further comprise one or more compounds selected from the group consisting of LiBOB, LiDFOB, LiDFOP, LiPO₂F₂, LiBF₄, LiSbF₆, LiAsF₆, LIN (SO₂CF₃)₂, LiN(SO₂C2F₅)₂, LiC(SO₂CF₃)₃, LiClO₄, LiAlCl₄, LiCF₃SO₃, LiSO₃F, Li₂B₁₀Cl₁₀, lithium chloroborane, lithium tetrafluorooxalate phosphate, lithium trioxalate phosphate, lower aliphatic carboxylate lithium with fewer than 4 carbon atoms, and lithium tetraphenylborate.

In some embodiments, the total molar content of the lithium salts is 0.9 mol/L to 3.5 mol/L, with 0.012≤F≤1; and in some preferred embodiments, the total molar content of the lithium salts is 1.1 mol/L to 1.5 mol/L, with 0.06≤F≤0.85. Specifically, the total molar content of the lithium salts may be but is not limited to 0.9 mol/L, 0.95 mol/L, 1.0 mol/L, 1.1 mol/L, 1.15 mol/L, 1.2 mol/L, 1.3 mol/L, 1.4 mol/L, 1.45 mol/L, 1.5 mol/L, 1.6 mol/L, 1.7 mol/L, 1.8 mol/L, 1.9 mol/L, 2.0 mol/L, 2.1 mol/L, 2.2 mol/L, 2.3 mol/L, 2.4 mol/L, 2.5 mol/L, 2.6 mol/L, 2.7 mol/L, 2.8 mol/L, 2.9 mol/L, 3.0 mol/L, 3.1 mol/L, 3.2 mol/L, 3.3 mol/L, 3.4 mol/L, or 3.5 mol/L.

In some embodiments, the non-aqueous organic solvent further comprises one or more compounds selected from the group consisting of a cyclic carbonate, a carboxylate ester, and an ether.

In some preferred embodiments, the cyclic carbonate comprises one or more compounds selected from the group consisting of ethylene carbonate, fluoroethylene carbonate (FEC), vinylene carbonate, propylene carbonate, and butene carbonate.

The chain carbonate further comprises one or more compounds selected from the group consisting of diethyl carbonate, ethyl methyl carbonate, and propyl methyl carbonate.

The carboxylate ester comprises one or more compounds selected from the group consisting of methyl acetate, ethyl acetate, propyl acetate, methyl propionate, ethyl propionate, propyl propionate, methyl butyrate, methyl isobutyrate, ethyl butyrate, methyl trimethylacetate, and ethyl trimethylacetate.

The ether comprises one or more compounds selected from the group consisting of dimethoxyethane, 1,3-dioxolane, and 1,1,2,2-tetrafluoroethyl-2,2,3,3-tetrafluoropropyl ether.

In some preferred embodiments, the non-aqueous organic solvent comprises a chain carbonate and a cyclic carbonate, and the cyclic carbonate comprises at least FEC. The content of FEC is 6% to 30% when the total mass of the non-aqueous electrolyte is taken as 100%. In electrolytes of silicon-containing battery systems, FEC not only facilitates interfacial film formation, but also facilitates the suppression of lithium consumption.

In some embodiments, the non-aqueous electrolyte further comprises an additive, which comprises one or more compounds selected from the group consisting of a cyclic carbonate compound, a cyclic sulfate compound, a sultone compound, a phosphate ester compound, a borate ester compound, and a nitrile compound.

In some preferred embodiments, the cyclic carbonate compound comprises one or more compounds selected from the group consisting of vinylene carbonate, ethylene carbonate, methylene ethylene carbonate, fluoroethylene carbonate, trifluoromethyl ethylene carbonate, difluoroethylene carbonate, and compounds represented by the following structural formula 1:

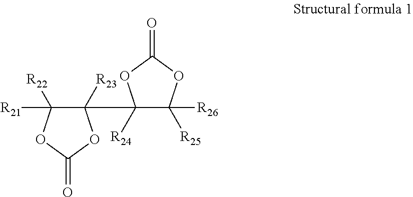

wherein R₂₁, R₂₂, R₂₃, R₂₄, R₂₅, and R₂₆ are independently selected from hydrogen atom, halogen atom, and C1 to C5 groups.

The cyclic sulfate compound comprises one or more compounds selected from the group consisting of vinyl sulfate, 4-methylvinyl sulfate, and propylene sulfate.

The sultone compound comprises one or more compounds selected from the group consisting of 1,3-propanesultone, 1,4-butanesultone, and prop-1-ene-1,3-sultone.

The phosphate ester compound comprises one or more compounds selected from the and compounds represented by the following structural formula 2:

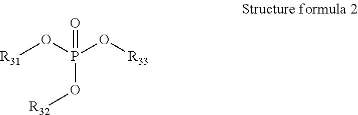

wherein R₃₁, R₃₂, and R₃₃ are independently selected from C1 to C5 saturated hydrocarbon groups, unsaturated hydrocarbon groups, halogenated hydrocarbon groups, and —Si(CₘH₂ₘ₊₁)₃, wherein m is a natural number in the range from 1 to 3, and at least one of R₃₁, R₃₂, and R₃₃ is an unsaturated hydrocarbon group.

The borate ester compound comprises one or more compounds selected from the group consisting of tris(trimethylsilane) borate ester and tris(triethylsilane) borate ester.

The nitrile compound comprises one or more compounds selected from the group consisting of succinitrile, glutaronitrile, ethylene glycol bis(propionitrile) ether, hexanetrinitrile, adiponitrile, dicyanopentane, octanedinitrile, azelanitrile, and sebacoitrile.

It should be noted that, unless otherwise specified, the content of any one of the optional substance in the additive in the non-aqueous electrolyte is less than 10% by weight. In preferred embodiments, the content ranges from 0.1% to 5% by weight, and in more preferred embodiments, the content ranges from 0.1% to 3% by weight. In specific embodiments, the content of any one of the optional substances in the additive may be, for example, 0.05%, 0.08%, 0.1%, 0.5%, 0.8%, 1%, 1.2%, 1.5%, 1.8%, 2%, 2.2%, 2.5%, 2.8%, 3%, 3.2%, 3.5%, 3.8%, 4%, 4.5%, 5%, 5.5%, 6%, 6.5%, 7%, 7.5%, 7.8%, 8%, 8.5%, 9%, 9.5%, or 10% by weight.

In some embodiments, the cathode comprises a cathode material layer containing a cathode active material. The type and content of the cathode active material are not particularly limited and may be selected according to actual needs as long as it is a cathode active material or conversion-type cathode material where metal ions, such as lithium ions, can be reversibly intercalated and deintercalated.

In some embodiments, the cathode active material may comprise at least one compound selected from the group consisting of LiFe₁₋ₓM′_{x′}PO₄, LiMn_{2-y′}M_{y′}O₄, and LiNiₓCo_{y}Mn₂M_{1-x-y-z}O₂, wherein M′ is at least one compound selected from the group consisting of Mn, Mg, Co, Ni, Cu, Zn, Al, Sn, B, Ga, Cr, Sr, W, Zr, V, and Ti, and M is at least one compound selected from the group consisting of Fe, Co, Ni, Mn, Mg, Cu, Zn, Al, Sn, B, Ga, Cr, Sr, W, Zr, V, and Ti, with 0≤x′<1, 0≤y′≤1, 0≤y≤1, 0≤x≤1, 0≤z≤1, and x+y+z≤1. The cathode active material may further comprise at least one compound selected from the group consisting of sulfides, selenides, and halides. In some more preferred embodiments, the cathode active material may comprise at least one compound selected from the group consisting of LiCoO₂, LiFePO₄, LiFe_{0.4}Mn_{0.6}PO₄, LiMn₂O₄, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNi_{0.8}Co_{0.15}Al_{0.05}O₂, LiNi_{0.9}Co_{0.05}Mn_{0.05}O₂, LiNi_{0.5}Co_{0.2}Mn_{0.2}Al_{0.1}O₂, and LiNi_{0.5}Co_{0.2}Al_{0.3}O₂.

In some embodiments, the cathode further comprises a cathode current collector, and the cathode material layer is disposed on the surface of the cathode current collector.

The cathode current collector is selected from metal materials that can conduct electrons. In some preferred embodiments, the cathode current collector comprises at least one of Al, Ni, Sn, Cu, and stainless steel. In more preferred embodiments, the cathode current collector is aluminum foil.

In some embodiments, the cathode active material layer further comprises a cathode binder and a cathode conductive agent, and the cathode active material, the cathode binder, and the cathode conductive agent are blended together to form the cathode material layer.

Further, the cathode binder comprises at least one selected from thermoplastic resins, such as polyvinylidene fluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-vinyl fluoride copolymer, vinylidene fluoride-hexafluoropropylene-tetrafluoroethylene copolymer, thermoplastic polyimide, polyethylene, and polypropylene; acrylic resins; and styrene-butadiene rubbers.

The cathode conductive agent comprises at least one of conductive carbon blacks, conductive carbon balls, conductive graphites, conductive carbon fibers, carbon nanotubes, graphenes, and reduced graphene oxides.

In some embodiments, the anode further includes an anode current collector, and the anode material layer is disposed on the surface of the anode current collector. The material of the anode current collector may be the same as that of the cathode current collector, and thus will not be repeated herein.

In some embodiments, the anode material layer further comprises an anode binder and an anode conductive agent, and the anode active material, the anode binder and the anode conductive agent are blended together to form the anode material layer. The anode binder and the anode conductive agent may be the same as the cathode binder and the cathode conductive agent, respectively, and thus will not be repeated herein.

In some embodiments of the present disclosure, the separator may be an existing conventional separator, which may be a ceramic separator, a polymer separator, a non-woven fabrics, or an inorganic-organic composite separator, including but not limited to single-layer polypropylene (PP), single-layer polyethylene (PE), double-layer PP/PE, double-layer PP/PP, and triple-layer PP/PE/PP.

The present application will be further described below with reference to specific embodiments.

### Embodiment 1

This embodiment is used to illustrate the cylindrical lithium-ion battery and the preparation method therefor according to the present application. The preparation method includes the following operation steps:

Cathode preparation: Mixing NCM811 (LiNi_{0.8}Co_{0.1}Mn_{0.1}O₂) serving as the high-nickel ternary cathode active material, a conductive carbon black, and polyvinylidene fluoride serving as the binder at a mass ratio of 97:1.5:1.5; dispersing the mixture in N-methyl-2-pyrrolidone to obtain a cathode slurry; evenly applying the cathode slurry onto both sides of an aluminum foil; performing drying, calendering, and vacuum drying in sequence, to form a cathode material layer on the aluminum foil; and then using an ultrasonic welder to weld an aluminum lead, to obtain a cathode plate, whose thickness is in the range from 120 μm to 150 μm.

Anode preparation: Mixing a silicon-carbon composite material (silicon oxide+graphite mixture), a conductive carbon black, styrene-butadiene rubber and sodium carboxymethyl cellulose serving as the binder at a mass ratio of 94.2:1.2:3.0:1.5; dispersing the mixture in deionized water to obtain an anode slurry; applying the anode slurry onto both sides of a copper foil; performing drying, calendering, and vacuum drying in sequence, to form an anode material layer (with the Si content of 6%) on the copper foil; and then using an ultrasonic welder to weld a nickel lead, to obtain an anode plate, whose thickness is in the range from 120 μm to 150 μm.

Electrolyte preparation: Mixing dimethyl carbonate (DMC), ethylene carbonate (EC), and fluoroethylene carbonate (FEC) at a certain mass ratio, and followed by adding LiFSI and LiPF₆ to obtain the electrolyte, in which the mass percentages of DMC and FEC are 75% and 10% respectively, and the molar contents of LiFSI and LiPF₆ are shown in Table 1.

Battery assembling: Placing a separator between the cathode plate and the anode plate to form a sandwich structure; winding up the sandwich structure to form a wound core; and placing the wound body into a cylindrical aluminum case.

Injection and formation: Injecting the electrolyte prepared as described above into battery cells; vacuum-sealing; and then aging for 36 h. Then, performing the first charging for conventional formation in the following steps: Charging at a constant current of 0.02 C for 30 min; charging at a constant current of 0.05 C for 30 min; charging at a constant current of 0.1 C for 120 min; charging at a constant current of 0.2 C for 240 min, terminating charging when the set cut-off voltage of 3.85 V is reached; resting for 1 h; resting at room temperature for 24 h (12 h when the battery is placed in the standard orientation, and 12 h when the battery is placed in the reverse orientation); charging at a constant current of 0.5 C to 4.2 V; and then discharging at a constant current of 0.2 C to 2.75 V.

### Embodiments 2 to 33

Embodiments 2 to 33 are used to illustrate the cylindrical lithium-ion battery and the preparation method therefor according to the present application, including most of the operation steps in Embodiment 1. The differences lie in the battery composition as shown in Table 1. Among these embodiments, the lithium fluorosulfonylimide in Embodiment 26 is LiTFSI.

### Comparative Examples 1 to 16

Comparative Examples 1 to 16 are used to illustrate the cylindrical lithium-ion battery and the preparation method therefor according to the present application, including most of the operation steps in Embodiment 1. The differences lie in the battery composition as shown in Table 1. Among these comparative examples, the non-aqueous electrolyte in Comparative Example 1 is free of FEC.

TABLE 1

| | | | | | | S (Si | | |
|---|---|---|---|---|---|---|---|---|
| | | | | | | content | | |
| | | | | Molar | | in the | | Type |
| | | D | Molar content | content | | anode | | and |
| | | (DMC | of lithium | of | F (lithium | material | | content |
| | Anode active | content), | fluorosulfonylimide, | LiPF₆, | fluorosulfonylimide/ | layer), | (1 − D) × | of |
| Item | material | % | mol/L | mol/L | LiPF₆) | wt % | F/S | additive |
| Embodiment | Silicon-carbon | 75 | 0.02 | 1.7 | 0.012 | 6 | 0.05 | — |
| 1 | composite | | | | | | | |
| | material | | | | | | | |
| Embodiment | Silicon-carbon | 75 | 0.03 | 1.5 | 0.020 | 5 | 0.10 | — |
| 2 | composite | | | | | | | |
| | material | | | | | | | |
| Embodiment | Silicon-carbon | 67 | 0.1 | 1.2 | 0.083 | 10 | 0.28 | — |
| 3 | composite | | | | | | | |
| | material | | | | | | | |
| Embodiment | Silicon-carbon | 60 | 0.1 | 1.7 | 0.059 | 12 | 0.20 | — |
| 4 | composite | | | | | | | |
| | material | | | | | | | |
| Embodiment | Silicon-carbon | 60 | 0.3 | 1.1 | 0.273 | 15 | 0.73 | — |
| 5 | composite | | | | | | | |
| | material | | | | | | | |
| Embodiment | Silicon-carbon | 60 | 0.6 | 0.6 | 1.000 | 8 | 5.00 | — |
| 6 | composite | | | | | | | |
| | material | | | | | | | |
| Embodiment | Silicon-carbon | 55 | 0.5 | 0.6 | 0.833 | 15 | 2.50 | — |
| 7 | composite | | | | | | | |
| | material | | | | | | | |
| Embodiment | Silicon-carbon | 55 | 0.5 | 0.6 | 0.833 | 5 | 7.50 | — |
| 8 | composite | | | | | | | |
| | material | | | | | | | |
| Embodiment | Silicon-carbon | 50 | 0.6 | 0.7 | 0.857 | 7 | 6.12 | — |
| 9 | composite | | | | | | | |
| | material | | | | | | | |
| Embodiment | Silicon-carbon | 50 | 0.7 | 0.8 | 0.875 | 5 | 8.75 | — |
| 10 | composite | | | | | | | |
| | material | | | | | | | |
| Embodiment | Silicon-carbon | 60 | 0.7 | 0.8 | 0.875 | 5 | 7.00 | — |
| 11 | composite | | | | | | | |
| | material | | | | | | | |
| Embodiment | Silicon-carbon | 55 | 0.7 | 0.8 | 0.875 | 5 | 7.88 | — |
| 12 | composite | | | | | | | |
| | material | | | | | | | |
| Embodiment | Silicon-carbon | 67 | 0.11 | 1.8 | 0.061 | 7 | 0.29 | — |
| 13 | composite | | | | | | | |
| | material | | | | | | | |
| Embodiment | Silicon-carbon | 55 | 1.2 | 1.5 | 0.800 | 7.5 | 4.80 | — |
| 14 | composite | | | | | | | |
| | material | | | | | | | |
| Embodiment | Silicon-carbon | 62 | 0.9 | 1 | 0.900 | 18 | 1.90 | — |
| 15 | composite | | | | | | | |
| | material | | | | | | | |
| Embodiment | Silicon-carbon | 65 | 0.04 | 1.1 | 0.036 | 6.5 | 0.20 | — |
| 16 | composite | | | | | | | |
| | material | | | | | | | |
| Embodiment | Silicon-carbon | 70 | 0.9 | 1.2 | 0.750 | 20 | 1.13 | — |
| 17 | composite | | | | | | | |
| | material | | | | | | | |
| Embodiment | Silicon-carbon | 72 | 0.3 | 1.8 | 0.167 | 6 | 0.78 | — |
| 18 | composite | | | | | | | |
| | material | | | | | | | |
| Embodiment | Silicon-carbon | 55 | 0.85 | 1 | 0.850 | 5 | 7.65 | — |
| 19 | composite | | | | | | | |
| | material | | | | | | | |
| Embodiment | Silicon-carbon | 67 | 0.05 | 1.1 | 0.045 | 10 | 0.15 | — |
| 20 | composite | | | | | | | |
| | material | | | | | | | |
| Embodiment | Silicon-carbon | 67 | 0.55 | 0.6 | 0.917 | 10 | 3.03 | — |
| 21 | composite | | | | | | | |
| | material | | | | | | | |
| Embodiment | Silicon-carbon | 60 | 0.3 | 1.1 | 0.273 | 18 | 0.61 | — |
| 22 | composite | | | | | | | |
| | material | | | | | | | |
| Embodiment | Silicon-carbon | 60 | 0.3 | 1.1 | 0.273 | 6 | 1.82 | — |
| 23 | composite | | | | | | | |
| | material | | | | | | | |
| Embodiment | Silicon-carbon | 72 | 0.1 | 1.2 | 0.083 | 10 | 0.23 | — |
| 24 | composite | | | | | | | |
| | material | | | | | | | |
| Embodiment | Silicon-carbon | 53 | 0.1 | 1.2 | 0.083 | 10 | 0.39 | — |
| 25 | composite | | | | | | | |
| | material | | | | | | | |
| Embodiment | Silicon-carbon | 67 | 0.1 | 1.2 | 0.083 | 10 | 0.28 | — |
| 26 | composite | | | | | | | |
| | material | | | | | | | |
| Embodiment | Mg₂Si alloy | 55 | 0.5 | 0.6 | 0.833 | 15 | 2.50 | — |
| 27 | material | | | | | | | |
| Embodiment | Silicon oxide | 55 | 0.5 | 0.6 | 0.833 | 15 | 2.50 | — |
| 28 | material (SiO) | | | | | | | |
| Embodiment | Nano-silicon | 60 | 0.3 | 1.1 | 0.273 | 15 | 0.73 | — |
| 29 | material | | | | | | | |
| Embodiment | Fe₂Si alloy | 60 | 0.3 | 1.1 | 0.273 | 15 | 0.73 | — |
| 30 | material | | | | | | | |
| Embodiment | Silicon-carbon | 60 | 0.3 | 1.1 | 0.273 | 15 | 0.73 | 1% |
| 31 | composite | | | | | | | DTD |
| | material | | | | | | | |
| Embodiment | Silicon-carbon | 60 | 0.3 | 1.1 | 0.273 | 15 | 0.73 | 1% |
| 32 | composite | | | | | | | PS |
| | material | | | | | | | |
| Embodiment | Silicon-carbon | 60 | 0.3 | 1.1 | 0.273 | 15 | 0.73 | 1% |
| 33 | composite | | | | | | | tripropargyl |
| | material | | | | | | | phosphate |
| Comparative | Silicon-carbon | 80 | 0.03 | 1.5 | 0.020 | 5 | 0.08 | — |
| Example 1 | composite | | | | | | | |
| | material | | | | | | | |
| Comparative | Silicon-carbon | 75 | 0.01 | 1.5 | 0.007 | 5 | 0.03 | — |
| Example 2 | composite | | | | | | | |
| | material | | | | | | | |
| Comparative | Silicon-carbon | 45 | 0.02 | 1.7 | 0.012 | 6 | 0.11 | — |
| Example 3 | composite | | | | | | | |
| | material | | | | | | | |
| Comparative | Silicon-carbon | 75 | 0.7 | 0.6 | 1.167 | 6 | 4.86 | — |
| Example 4 | composite | | | | | | | |
| | material | | | | | | | |
| Comparative | Silicon-carbon | 60 | 0.1 | 1.7 | 0.059 | 2 | 1.18 | — |
| Example 5 | composite | | | | | | | |
| | material | | | | | | | |
| Comparative | Silicon-carbon | 60 | 0.1 | 1.7 | 0.059 | 22 | 0.11 | — |
| Example 6 | composite | | | | | | | |
| | material | | | | | | | |
| Comparative | Silicon-carbon | 45 | 0.01 | 1.8 | 0.006 | 6 | 0.05 | — |
| Example 7 | composite | | | | | | | |
| | material | | | | | | | |
| Comparative | Silicon-carbon | 45 | 0.01 | 1.8 | 0.006 | 2 | 0.15 | — |
| Example 8 | composite | | | | | | | |
| | material | | | | | | | |
| Comparative | Silicon-carbon | 45 | 0.01 | 1.8 | 0.006 | 25 | 0.01 | — |
| Example 9 | composite | | | | | | | |
| | material | | | | | | | |
| Comparative | Silicon-carbon | 75 | 0.01 | 0.8 | 0.013 | 20 | 0.02 | — |
| Example 10 | composite | | | | | | | |
| | material | | | | | | | |
| Comparative | Silicon-carbon | 50 | 0.6 | 0.6 | 1.000 | 5 | 10.00 | — |
| Example 11 | composite | | | | | | | |
| | material | | | | | | | |
| Comparative | Silicon-carbon | 80 | 0.3 | 1.1 | 0.273 | 15 | 0.36 | — |
| Example 12 | composite | | | | | | | |
| | material | | | | | | | |
| Comparative | Silicon-carbon | 65 | 0.02 | 1.7 | 0.012 | 10 | 0.04 | — |
| Example 13 | composite | | | | | | | |
| | material | | | | | | | |
| Comparative | Silicon-carbon | 65 | 0.03 | 1.4 | 0.021 | 20 | 0.04 | — |
| Example 14 | composite | | | | | | | |
| | material | | | | | | | |
| Comparative | Silicon-carbon | 50 | 0.9 | 1 | 0.900 | 5 | 9.00 | — |
| Example 15 | composite | | | | | | | |
| | material | | | | | | | |
| Comparative | Silicon-carbon | 55 | 0.8 | 0.8 | 1.000 | 5 | 9.00 | — |
| Example 16 | composite | | | | | | | |
| | material | | | | | | | |

### Performance Tests

The following performance tests were performed on the cylindrical lithium-ion batteries prepared in the above embodiments and comparative examples, and the results are shown in Table 2.

1) Rate discharge efficiency test: At 25° C., the formed battery cell was charged with constant current and contant voltage (CC-CV) of 0.5 C to 4.2 V, then discharged with a constant current of 0.5 C to 2.75 V, then charged with a constant voltage and a constant current of 0.5 C to 4.2 V, and then discharged with a constant current of 4 C to 2.75 V. Finally, the ratio of the discharge capacity at 4 C to the discharge capacity at 0.5 C was calculated. The calculation formula is as follows:

4 C/0.5 C Rate Discharge Efficiency (%)=(Discharge Capacity at 4 C/Discharge Capacity at 0.5 C)×100%;

2) Room-temperature cycle performance test: At 25° C., the formed battery was charged with a constant current and constant voltage current (CC-CV) of 1 C to 4.2 V, and then discharged with a constant current of 1 C to 2.75 V. After 1000 cycles of charging and discharging, the capacity retention rate of the 1000th cycle was calculated. The calculation formula is as follows:

Capacity Retention Rate at the 1000th Cycle (%)=(Discharge Capacity at the 1000th Cycle/Discharge Capacity at the First Cycle)×100%;

3) Ultra-high temperature storage performance test: The formed battery was charged at room temperature with a constant voltage and a constant current of 1 C to 4.2 V, then discharged with a constant current of 1 C to 2.75 V, then charged with a constant voltage and a constant current of 1 C to 4.2 V, then stored at 85° C. for 12 h, and then discharged with a constant current of 1 C to 2.75 V after the battery cell was cooled down to room-temperature to measure the battery's retention capacity. The calculation formula is as follows:

Capacity Retention Rate (%)=Retained Capacity/Initial Capacity×100%.

TABLE 2

| | 4 C/0.5 C rate | Room-temperature | Capacity retention |
|---|---|---|---|
| | discharge | Capacity retention rate | rate after storage |
| Item | efficiency | after 1000 cycles | at 85 °C for 12 h |
| Embodiment 1 | 81.2% | 80.2% | 74.3% |
| Embodiment 2 | 82.9% | 80.1% | 75.6% |
| Embodiment 3 | 87.2% | 89.2% | 83.2% |
| Embodiment 4 | 85.1% | 86.2% | 84.4% |
| Embodiment 5 | 86.3% | 90.2% | 83.1% |
| Embodiment 6 | 88.5% | 85.3% | 84.7% |
| Embodiment 7 | 88.0% | 90.3% | 85.2% |
| Embodiment 8 | 87.2% | 85.4% | 75.3% |
| Embodiment 9 | 83.4% | 84.0% | 86.9% |
| Embodiment 10 | 83.2% | 83.2% | 77.2% |
| Embodiment 11 | 85.1% | 85.3% | 79.8% |
| Embodiment 12 | 85.9% | 84.7% | 78.9% |
| Embodiment 13 | 87.1% | 90.3% | 84.0% |
| Embodiment 14 | 90.1% | 89.2% | 84.6% |
| Embodiment 15 | 87.9% | 82.1% | 84.9% |
| Embodiment 16 | 83.4% | 87.2% | 73.7% |
| Embodiment 17 | 88.8% | 80.1% | 77.2% |
| Embodiment 18 | 88.3% | 80.3% | 77.9% |
| Embodiment 19 | 89.2% | 88.9% | 74.5% |
| Embodiment 20 | 86.8% | 86.8% | 84.2% |
| Embodiment 21 | 87.0% | 86.3% | 84.9% |
| Embodiment 22 | 85.3% | 88.6% | 83.4% |
| Embodiment 23 | 84.1% | 84.2% | 73.9% |
| Embodiment 24 | 86.0% | 90.2% | 76.3% |
| Embodiment 25 | 82.1% | 86.3% | 85.2% |
| Embodiment 26 | 86.4% | 87.9% | 82.9% |
| Embodiment 27 | 84.3% | 83.2% | 82.1% |
| Embodiment 28 | 85.3% | 88.4% | 82.5% |
| Embodiment 29 | 80.2% | 86.9% | 80.3% |
| Embodiment 30 | 83.9% | 80.3% | 80.4% |
| Embodiment 31 | 89.1% | 92.1% | 88.8% |
| Embodiment 32 | 88.7% | 90.1% | 89.2% |
| Embodiment 33 | 84.2% | 88.2% | 89.7% |
| Comparative Example 1 | 52.4% | Diving | 35.0% |
| Comparative Example 2 | 73.1% | 72.3% | 74.7% |
| Comparative Example 3 | 72.1% | 76.0% | 79.2% |
| Comparative Example 4 | 80.9% | 71.1% | 65.9% |
| Comparative Example 5 | 72.2% | 74.5% | 75.3% |
| Comparative Example 6 | 75.3% | 61.2% | 60.2% |
| Comparative Example 7 | 71.8% | 73.0% | 71.0% |
| Comparative Example 8 | 72.9% | 73.2% | 73.9% |
| Comparative Example 9 | 70.1% | Diving | Untestable |
| Comparative Example 10 | 72.1% | Diving | 61.2% |
| Comparative Example 11 | 78.3% | 75.2% | Untestable |
| Comparative Example 12 | 84.1% | 86.1% | Untestable |
| Comparative Example 13 | 82.1% | 73.2% | 73.0% |
| Comparative Example 14 | 77.9% | 78.2% | 75.8% |
| Comparative Example 15 | 71.2% | Diving | 78.0% |
| Comparative Example 16 | 73.2% | Diving | 74.1% |

It can be seen from the data in Table 2 that when the mass percentage of DMC (D) in the non-aqueous electrolyte, the ratio of the molar content of lithium fluorosulfonylimide to that of LiPF₆ (F) in the non-aqueous electrolyte, and the mass percentage of silicon(S) in the anode material layer satisfy the condition of 0.05≤(100−D)×F/S≤8.75, with 50≤D≤75, 0.012≤F≤1, and 5≤S≤20, these values can effectively improve the rate discharge efficiency, room-temperature cycle performance, and ultra-high temperature storage performance of cylindrical lithium-ion batteries (as Embodiments 1 to 33). In particular, when the cylindrical lithium-ion battery meets the condition of 0.1≤(100−D)×F/S≤7.5, with 55≤D≤67, 0.06≤F≤0.85, and 7≤S≤15, the overall performances of the battery is better (such as Embodiment 3, Embodiment 5, Embodiment 7, Embodiment 13, and Embodiment 14). When at least one values (100−D)×F/S, D, F, and S is not within the preferred range, the relevant performance of the battery will be slightly degraded. For example, compared with Embodiment 3, the D value for the battery of Embodiment 24 is higher than the preferred range, and the ultra-high temperature storage performance decreases; and the D value for the battery of Embodiment 25 is lower than the preferred range, and the rate discharge efficiency and room temperature cycle performance decrease. Compared with Embodiment 3, the F value for the battery of Embodiment 20 is lower than the preferred range, and the room-temperature cycle performance decreases; and the F value for the battery of Embodiment 21 is higher than the preferred range, and the room-temperature cycle performance decreases. Compared with Embodiment 5, the S value for the battery of Embodiment 22 is higher than the preferred range, and the room-temperature cycle performance decreases; and the S value for the battery of Embodiment 23 is lower than the preferred range, and the room-temperature cycle performance and ultra-high temperature storage performance decrease. When two or more values (100−D)× F/S, D, F, and S are not within the preferred range, the relevant performance of the battery is more significantly degraded, such as the comparison of battery performance in Embodiments 10 to 12; when all of the values (100−D)×F/S, D, F, and S are not within the preferred range, the battery performance is relatively poorer (such as Embodiment 10).

The lithium fluorosulfonylimide in the non-aqueous electrolyte of the lithium-ion battery according to the present application may include one or more compounds selected from the group consisting of LiFSI (as Embodiments 1 to 25 and Embodiments 27 to 33) and LiTFSI (as Embodiment 26), all of which can meet the requirements. The preferable one LiFSI, with which the battery can have better performance (as shown by comparing Embodiment 3 and Embodiment 26).

The silicon-based material in the anode active material of the lithium-ion battery according to the present application may include one or more materials selected from the group consisting of silicon materials, silicon oxide materials, silicon-carbon composite materials, and silicon alloy materials, all of which can meet the requirements. In particular, when the silicon-based material may be selected from silicon-carbon composite materials, the battery can obtain better performance (as shown by comparing Embodiment 7 and Embodiments 27 to 28 and comparing Embodiment 5 and Embodiments 29 to 30).

The non-aqueous electrolyte of the lithium-ion battery according to the present application may further include conventional additives in the art, which can further improve the comprehensive performance of the battery. For example, compared with Embodiment 5, when 1% DTD is added to the non-aqueous electrolyte of the battery as in Embodiment 31, the rate discharge efficiency, room-temperature cycle performance, and ultra-high temperature storage performance of the battery are further improved; further, when 1% PS is added to the non-aqueous electrolyte of the battery as in Embodiment 32, the rate discharge efficiency and ultra-high temperature storage performance of the battery are further improved; and further, when 1% tripropargyl phosphate (TPP) is added to the non-aqueous electrolyte of the battery as in Embodiment 33, the ultra-high temperature storage performance of the battery is further improved.

When the cylindrical lithium-ion battery failed to satisfy the condition of 0.1≤(100−D)×F/S≤7.5, with 55≤D≤67, 0.06≤F≤0.85, and 7≤S≤15, the battery performance is significantly deteriorated as follows:

Compared with Embodiment 2, when the DMC content D in the non-aqueous electrolyte of the battery is higher than the scope of the present application and there is no FEC in the non-aqueous electrolyte as in Comparative Example 1, the interface protection is insufficient, and the rate discharge efficiency, room-temperature cycle performance, and ultra-high temperature storage performance of the battery are seriously deteriorated.

Compared with Embodiment 1, when the DMC content D in the non-aqueous electrolyte of the battery is lower than the scope of the present application as in Comparative Example 3, the electrolyte wettability is poor, and the battery performance is significantly deteriorated.

Compared with Embodiment 2, when the ratio F of the molar content of the lithium fluorosulfonylimide to the molar content of LiPF₆ in the non-aqueous electrolyte of the battery is lower than the scope of the present application as in Comparative Example 2, the conductivity is insufficient, and the battery performance is degraded accordingly. Compared with Embodiment 1, when the ratio F of the molar content of the lithium fluorosulfonylimide to the molar content of LiPF₆ in the non-aqueous electrolyte of the battery is higher than the scope of the present application as in Comparative Example 4, the interface corrosion becomes severe, and the battery performance is significantly deteriorated.

Compared with Embodiment 4, when the mass percentage S of silicon in the anode material layer of the battery is lower than the scope of the present application as in Comparative Example 5, or when the mass percentage S of silicon in the anode material layer of the battery is higher than the scope of the present application as in Comparative Example 6, the battery composition is mismatched, the material is damaged, leading to significant degradation of battery performance.

Compared with Embodiment 1, when the DMC content D in the non-aqueous electrolyte of the battery is lower than the scope of the present application and the ratio F of the molar content of the lithium fluorosulfonylimide to the molar content of LiPF₆ is lower than the scope of the present application as in Comparative Example 7, the battery performance is significantly deteriorated. Compared with Comparative Example 3, when the F value for the non-aqueous electrolyte of the battery is reduced to be lower than that of the present application as in Comparative Example 7, the battery performance is further deteriorated. Compared with Comparative Example 7, when the mass percentage S of silicon in the anode material layer of the battery is reduced as in Comparative Example 8, although the battery performance is slightly improved, it is still significantly degraded compared with the present application.

When the parameter indicators of the battery do not meet the requirements of the present application as in Comparative Example 9, the battery performance is deteriorated seriously, with a diving phenomenon, and the ultra-high temperature storage performance cannot be tested.

When the ratio F of the mass percentage S of silicon in the anode material layer of the battery does not match with the molar content F of lithium fluorosulfonylimide and LiPF₆ in the non-aqueous electrolyte as in Comparative Example 10, or when the mass percentage S of silicon in the anode material layer of the battery does not match with the DMC content D in the non-aqueous electrolyte and the value of (100−D)×F/S is not within the scope of this application as in Comparative Example 11, the battery performance is seriously deteriorated, and the ultra-high temperature storage performance cannot be tested.

Compared with Embodiment 5, when the DMC content D in the non-aqueous electrolyte of the battery is higher than the scope of this application as in Comparative Example 12, the ultra-high temperature storage performance cannot be tested.

In the batteries of Comparative Examples 13 to 16, although the mass percentage D of DMC in the non-aqueous electrolyte, the ratio F of the molar content of the lithium fluorosulfonylimide to the molar content of LiPF₆ in the non-aqueous electrolyte, and the mass percentage S of silicon in the anode material layer all meet the requirements of this application, the value of (100−D)×F/S is not within the scope of this application, which also leads to severe deterioration of battery performance. These results show that only when appropriate key battery components are selected and the relationship between the amounts and content of the key components meets the specific requirements of the present application, the lithium-ion battery can be guaranteed to have the excellent performance described in the present application.

In summary, according to the present application, by controlling the mass percentage D of DMC in the non-aqueous electrolyte, the ratio F of the molar content of the lithium fluorosulfonylimide to the molar content of LiPF₆ in the non-aqueous electrolyte, and the mass percentage S of silicon in the anode material layer are controlled to satisfy the condition of 0.05≤(100−D)×F/S≤8.75, with 50≤D≤75, 0.012≤F≤1, and 5≤S≤20, these values can effectively suppress the volume change of silicon anodes, and improve the problems such as consumption and active lithium loss of the electrolyte, interface impedance increase, cycle performance degradation, and rapid battery capacity attenuation in the later stage of cycle, thereby improving the rate capability, room-temperature cycle performance and ultra-high temperature storage performance of cylindrical lithium-ion batteries, and increasing their service lives.

The technical features of the above embodiments can be combined arbitrarily. For concise description, not all possible combinations of the technical features in the above embodiments are described. However, as long as there is no contradiction between the combinations of these technical features, they shall be considered to fall within the scope of this specification.

The above embodiments merely represent several embodiment methods of the present application. Although they are described in a relatively specific and detailed manner, they shall not be construed as a limitation on the scope of the present application. It should be pointed out that those of ordinary skill in the art can make various modifications and improvements without departing from the spirit of the present application, and such modifications and improvements shall also fall within the scope of protection of the present application. Therefore, the protection scope of the present application shall be subject to the attached claims.

What is claimed is:

1. A cylindrical lithium-ion battery, comprising a cathode, an anode, and a non-aqueous electrolyte, wherein the anode comprises an anode material layer containing an anode active material, which comprises a silicon-based material; the non-aqueous electrolyte comprises a non-aqueous organic solvent and lithium salts, wherein the non-aqueous organic solvent comprises a chain carbonate containing dimethyl carbonate, and the lithium salts comprise LiPF₆ and a lithium fluorosulfonylimide;
the cylindrical lithium-ion battery satisfies the following conditions:
0.05≤(100−D)×F/S≤8.75, with 50≤D≤75, 0.012≤F≤1, and 5≤S≤20;
wherein D is the mass percentage of dimethyl carbonate in the non-aqueous electrolyte, in wt %;
F is the ratio of the molar content of the lithium fluorosulfonylimide to the molar content of LiPF₆ in the non-aqueous electrolyte; and
S is the mass percentage of silicon in the anode material layer, in wt %.

2. The cylindrical lithium-ion battery according to claim 1, wherein the cylindrical lithium-ion battery satisfies the following condition: 0.1≤(100−D)×F/S≤7.5.

3. The cylindrical lithium-ion battery according to claim 1, wherein the mass percentage D of dimethyl carbonate in the non-aqueous electrolyte is 55 wt % to 67 wt %.

4. The cylindrical lithium-ion battery according to claim 1, wherein the ratio F of the molar content of the lithium fluorosulfonylimide to the molar content of LiPF₆ in the non-aqueous electrolyte is 0.06 to 0.85.

5. The cylindrical lithium-ion battery according to claim 1, wherein the mass percentage S of silicon in the anode material layer is 7 wt % to 15 wt %.

6. The cylindrical lithium-ion battery according to claim 1, wherein the silicon-based material comprises one or more materials selected from the group consisting of silicon materials, silicon oxide materials, silicon-carbon composite materials, and silicon alloy materials.

7. The cylindrical lithium-ion battery according to claim 1, wherein the lithium fluorosulfonylimide comprises one or more compounds selected from the group consisting of lithium bis(fluorosulfonyl)imide and lithium bis(trifluoromethanesulfonyl)imide.

8. The cylindrical lithium-ion battery according to claim 1, wherein the total molar content of the lithium salts is 0.9 mol/L to 3.5 mol/L, and the ratio F of the molar content of the lithium fluorosulfonylimide to the molar content of LiPF₆ in the non-aqueous electrolyte is 0.012 to 1.

9. The cylindrical lithium-ion battery according to claim 8, wherein the total molar content of the lithium salts is 1.1 mol/L to 1.5 mol/L, and the ratio F of the molar content of the lithium fluorosulfonylimide to the molar content of LiPF₆ in the non-aqueous electrolyte is 0.06 to 0.85.

10. The cylindrical lithium-ion battery according to claim 1, wherein the non-aqueous organic solvent further comprises one or more compounds selected from the group consisting of a cyclic carbonate, a carboxylate ester, and an ether.

11. The cylindrical lithium-ion battery according to claim 10, wherein the cyclic carbonate comprises one or more compounds selected from the group consisting of ethylene carbonate, fluoroethylene carbonate, vinylene carbonate, propylene carbonate, and butylene carbonate;
the chain carbonate further comprises one or more compounds selected from the group consisting of diethyl carbonate, ethyl methyl carbonate, and propyl methyl carbonate;
the carboxylate ester comprises one or more compounds selected from the group consisting of methyl acetate, ethyl acetate, methyl propionate, ethyl propionate, methyl butyrate, methyl isobutyrate, methyl trimethylacetate, and ethyl trimethylacetate; and
the ether comprises one or more compounds selected from the group consisting of dimethoxyethane, 1,3-dioxolane, and 1,1,2,2-tetrafluoroethyl-2,2,3,3-tetrafluoropropyl ether.

12. The cylindrical lithium-ion battery according to claim 1, wherein the non-aqueous electrolyte further comprises an additive, which comprises one or more compounds selected from the group consisting of a cyclic carbonate compound, a cyclic sulfate compound, a sultone compound, a phosphate ester compound, a borate ester compound, and a nitrile compound; and the content of the additive is 0.01% to 10% when the total mass of the non-aqueous electrolyte is taken as 100%.

13. A cylindrical lithium-ion battery as claimed in claim 12, wherein the cyclic carbonate compound comprises one or more compounds selected from the group consisting of vinylene carbonate, ethylene carbonate, methylene ethylene carbonate, fluoroethylene carbonate, trifluoromethyl ethylene carbonate, difluoroethylene carbonate, and compounds represented by the following structural formula 1: 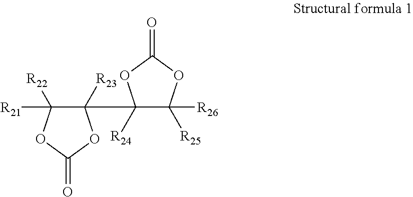
wherein R₂₁, R₂₂, R₂₃, R₂₄, R₂₅, and R₂₆ are independently selected from hydrogen atom, halogen atom, and C1 to C5 groups respectively;
the cyclic sulfate compound comprises one or more compounds selected from the group consisting of vinyl sulfate, 4-methylvinyl sulfate, and propylene sulfate;
the sultone compound comprises one or more compounds selected from the group consisting of 1,3-propanesultone, 1,4-butanesultone, and prop-1-ene-1,3-sultone;
the phosphate ester compound comprises one or more compounds selected from the group consisting of tris(trimethylsilane) phosphate ester, tris(triethylsilane) phosphate ester, and compounds represented by the following structural formula 2: 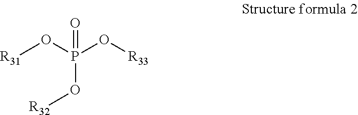
R₃₁, R₃₂, and R₃₃ are independently selected from C1 to C5 saturated hydrocarbon groups, unsaturated hydrocarbon groups, halogenated hydrocarbon groups, and —Si(CₘH₂ₘ₊₁)₃, where m is a natural number in the range from 1 to 3, and at least one of R₃₁, R₃₂, and R₃₃ is an unsaturated hydrocarbon group;
the borate ester compound comprises one or more compounds selected from the group consisting of tris(trimethylsilane)borate ester and tris(triethylsilane)borate ester; and
the nitrile compound comprises one or more compounds selected from the group consisting of succinitrile, glutaronitrile, ethylene glycol bis(propionitrile) ether, hexanetrinitrile, adiponitrile, dicyanopentane, octanedinitrile, azelanitrile, and sebacoitrile.
